(19) United States
(12) Patent Application Publication
(10) Pub. No.: US 2022/0147050 A1
(43) Pub. Date: May 12, 2022

(54) METHODS AND DEVICES FOR OPERATING AN INTELLIGENT MOBILE ROBOT

(71) Applicants: Meteorolite Ltd., San Francisco, CA (US); Guangzhou Thirty Seven Degree Smarthome Co., Ltd., Guangzhou (CN)

(72) Inventor: Hui CHENG, Bridgewater, NJ (US)

(21) Appl. No.: 17/094,512

(22) Filed: Nov. 10, 2020

(51) Int. Cl. G05D 1/02; G06K 9/00; G06K 9/62; G06F 16/245; G06F 16/22; G06F 16/583; G06F 16/55

(52) U.S. Cl. CPC G05D 1/0219; G06K 9/00664; G06K 9/627; G06K 9/6218; G06K 9/6253; G01S 17/931; G06F 16/245; G06F 16/22; G06F 16/5854; G06F 16/55; G05D 2201/0215; G05D 1/0251

(57) ABSTRACT

A method for operating a mobile robot is described. The method includes determining that an object is in a first path of the mobile robot, searching a database for the object in or adjacent to the first path of the mobile robot, selecting an identified object in the database corresponding to the object, determining whether the identified object is valued, responsive to selecting the identified object in the database, and storing information associated with the object in the database, responsive to determining that the identified object is valued. Related systems, devices and computer program products are also described.

### FIELD

Various embodiments described herein relate to mobile robot devices, and more specifically to an intelligent autonomous mobile robot device.

### BACKGROUND

Vacuum robots have relieved people from tedious floor cleaning chores. Advanced robot vacuum cleaners use cameras to determine positioning and/or objects that are in or adjacent to the path of the robot vacuum cleaner. Robot vacuum cleaners may create a map of a room or house in order to efficiently clean. These maps tend to capture a layout of the room and/or fixed objects such as furniture. However, a map generated by current robot vacuum cleaners may not include objects that are accidentally dropped or temporarily placed on the floor by occupants of the house. Therefore, innovative solutions are needed to address the challenges of operating a robot vacuum cleaner in a house with normal daily behavior of its occupants.

### SUMMARY

Various embodiments of the present invention are directed to a method for operating a mobile robot. The method for operating a mobile robot includes determining that an object is in or adjacent to a first path of the mobile robot, searching a database for the object in or adjacent to the first path of the mobile robot, selecting an identified object in the database corresponding to the object, determining whether the identified object is valued, responsive to selecting the identified object in the database, and storing information associated with the object in the database, responsive to determining that the identified object is valued.

According to some embodiments, the method may include determining a second path for the mobile robot that is different from the first path, responsive to determining that the identified object is valued. The method may include removing the object, responsive to determining that the identified object is not valued. A location of the object/or and a timestamp of when the object was detected to be of value or removed for lack of value may be stored in the database. Selecting the identified object in the database corresponding to the object may include classifying one or more parameters associated with the object to generate a clustering score, and selecting the identified object in the database based on the clustering score. The one or more parameters may include a detection time, object location, object similarity, or object profile. Selecting the identified object in the database based on the clustering score may include comparing the clustering score to threshold values associated with respective candidate objects in the database, and selecting the identified object among the respective candidate objects based on the comparing the clustering score to the threshold values.

According to some embodiments, selecting the identified object in the database corresponding to the object may include classifying one or more parameters associated with the object to generate a clustering score, selecting a plurality of candidate objects in the database based on the clustering score, transmitting information related to the plurality of candidate objects to a user device, and receiving, from the user device, a selection of the identified object out of the plurality of candidate objects.

According to some embodiments, the method may include capturing first sensor information of an area prior to cleaning the area, capturing second sensor information of the area after cleaning the area, comparing the first sensor information and the second sensor information to determine if a change occurred, and identifying the object based on a difference between the first sensor information and the second sensor information, responsive to determining that the change occurred. The method may include capturing a first image of an area prior to cleaning the area, capturing a second image of the area after cleaning the area, comparing the first image and the second image to determine if a change in the area occurred, and identifying the object in the second image, responsive to determining that the change in the area occurred.

According to some embodiments, an alert may be generated, responsive to determining that the identified object is valued. The alert may be transmitted to a user device that is in communication with the mobile robot. An action associated with the identified object in the database may be identified, and the action that was identified may be performed on the object.

According to some embodiments, responsive to not finding the identified object in the database the method may include determining that an event of the mobile robot includes the mobile robot not being hindered, and determining an action for the mobile robot, responsive to the event of the mobile robot not being hindered.

According to some embodiments, it may be determined that an event of the mobile robot includes the mobile robot being hindered. An action for the mobile robot may be determined, responsive to the event of the mobile robot being hindered. A second path may be determined for the mobile robot that is different from the first path. The second path for the mobile robot may not include a location where the event of the mobile robot was hindered. In some embodiments, the second path for the mobile robot may include the location where the event of the mobile robot is hindered by the object, such that a second direction of the second path to the location is different from a first direction of the first path to the location. The database may be searched for a previous occurrence of the event at a location of the object. Corrective action information corresponding to the first path and the location that hindered the mobile robot may be stored in the database, responsive to not finding the previous occurrence of the event at the location in the database.

Various embodiments of the present invention are directed to a mobile robot device. The mobile robot device includes a transceiver, one or more processors coupled to the transceiver, and a memory coupled to the one or more processors, the memory including a non-transitory computer-readable storage medium storing computer-readable program code therein that is executable by the one or more processors to perform various operations. The various operations include determining that an object is in a first path of the mobile robot device, searching a database for the object in or adjacent to the first path of the mobile robot device, selecting an identified object in the database corresponding to the object, determining whether the identified object is valued, responsive to selecting the identified object in the database, and storing information associated with the object in the database, responsive to determining that the identified object is valued. Selecting the identified object in the database corresponding to the object may include classifying one or more parameters associated with the object to generate a clustering score, comparing the clustering score to threshold values associated with respective candidate objects in the database, and selecting the identified object among the candidate objects based on the comparing the clustering score to the threshold values. In some embodiments, selecting the identified object in the database corresponding to the object may include classifying one or more parameters associated with the object to generate a clustering score, and selecting a plurality of candidate objects in the database based on the clustering score. The transceiver may be configured to transmit information related to the plurality of candidate objects to a user device. The transceiver may be configured to receive, from the user device, a selection of the identified object out of the plurality of candidate objects.

It is noted that aspects of the inventive concepts described with respect to one embodiment, may be incorporated in a different embodiment although not specifically described relative thereto. That is, all embodiments and/or features of any embodiment can be combined in any way and/or combination. Other operations according to any of the embodiments described herein may also be performed. These and other aspects of the inventive concepts are described in detail in the specification set forth below.

### BRIEF DESCRIPTION OF THE DRAWINGS

The accompanying drawings are included to provide a further understanding of the present disclosure and are incorporated in and constitute a part of this application. These drawings illustrate certain example embodiments. In the drawings:

FIG. 1 illustrates an operating environment of a mobile robot device, according to some embodiments of the present inventive concept.

FIG. 2 illustrates various circuits and/or modules for object detection by a mobile robot device, according to some embodiments of the present inventive concept.

FIG. 3 and FIG. 4 are flowcharts of operations for object detection by a mobile robot device, according to some embodiments of the present inventive concept.

FIGS. 5 to 18 are flowcharts of operations of a mobile robot device, according to some embodiments of the present inventive concept.

FIG. 19 is a block diagram of a mobile robot device, according to various embodiments described herein.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

Vacuuming and cleaning of floors in a house or an office building is often a tedious and time-consuming task. Robot vacuum cleaners have relieved people of at least a portion of this tedious cleaning chore. Some robot vacuum cleaners may use cameras to localize the location and/or detect walls or boundaries of the path of the vacuum cleaner. However, these systems may poorly distinguish between objects on the floor, with poor accuracy and high false/inaccurate identification rates. These robot vacuum cleaners may lift most objects in the path from the floor without discrimination, including accidentally dropped items such as jewelry or money, or articles of clothing that are placed on the floor. Small objects such as jewelry may be mixed with the dust in the vacuum's dust reservoir or dust bin. Thus, small objects such as jewelry may be difficult to spot by the user when the reservoir is emptied. Therefore, there is a need for robot vacuum cleaners to detect objects during cleaning prior to suctioning, avoid the objects, alert a user of a possible valuable object on the floor, and/or catalog objects that are detected prior to suctioning and/or after suctioning.

Additionally, robot vacuum cleaners may repeatedly collide with the same object that is not detected by the sensors of the robot vacuum cleaner. The robot vacuum cleaner may also repeatedly get stuck in the same area or on the same obstruction during different vacuuming cycles. Therefore, there is a need for robot vacuum cleaners to detect objects and events during operation, and store location and temporal information related to the obstructions. This location and temporal information may be used by the robot vacuum cleaner to perform actions to avoid repeatedly getting stuck at the same location multiple times and/or to determine different paths or patterns of operation that avoid the obstruction or handle the obstruction in a different manner. For example, a robot vacuum cleaner may have gotten stuck on a small welcome rug during previous vacuuming sessions. During a subsequent vacuuming session, the robot vacuum cleaner may approach the welcome rug from a different approach angle to see if it can successfully navigate and clean the welcome rug from a different path direction. During a subsequent vacuuming session, the robot vacuum cleaner may perform operations such as increasing power to the wheels since the texture of the welcome rug may be different from a smoother floor area surrounding the welcome rug. These various actions taken during different vacuuming sessions may be stored and used to determine future actions upon detecting the welcome rug.

Machine learning techniques may be applied to determine the action that is taken by the mobile vacuum cleaner. A deep neural network (DNN) using layers of nodes to develop a machine learning model based on input information may be used to determine the action that should be taken by the mobile vacuum cleaner. For example, the first several iterations of operating the mobile vacuum cleaner in a room may allow for training and/or development of the machine learning model. The machine learning model may find patterns in the training data corresponding to the target object, such as the welcome rug. For example, attributes such as different paths taken in traveling to the welcome rug, various speeds and power levels used by the mobile vacuum cleaner when cleaning the welcome rug, and/or other parameters may be collectively classified based on success in cleaning the welcome rug. The machine learning model that was developed based on previous operations of the mobile vacuum cleaner may be used during subsequent operation of the mobile vacuum cleaner to make a prediction of a subsequent action that can be taken in the given situation. Therefore, future iterations of operating the mobile vacuum cleaner may not get stuck on the welcome mat and may be able to successfully clean the welcome rug. Similar operations may be used to learn the locations of objects that may not be easily detectable. For example, if the mobile vacuum cleaner does not detect an object such as a furniture object that has a large portion at a higher level than the mobile vacuum cleaner, the mobile vacuum cleaner may become stuck on the legs of the furniture object. The machine learning (ML) module may learn that the mobile vacuum cleaner often gets stuck in a specific location in a room. The machine learning module may thus predict an action that avoids the particular area where the furniture object is located.

The mobile vacuum cleaner may encounter various types of objects in a room. The mobile vacuum cleaner may classify one or more parameters associated with the object to generate a clustering score. An object in the database may be identified based on the clustering score. Parameters associated with the unknown object may include a detection time, object location, object similarity, or object profile. The identified object may be selected from the database based on the clustering score by comparing the clustering score to threshold values associated with respective candidate objects in the database. The identified object may be selected out of the candidate objects based on the comparing the clustering score to the threshold values.

Once the object is identified, actions that should be taken may be predicted by machine learning or the DNN when small objects such as paper clips, staples, jewelry, or coins are detected. The DNN may develop a machine learning model over various iterations of the mobile vacuum cleaner operating in an operating environment such as a house. The mobile vacuum cleaner may detect items such as paper clips and staples and classify these items as non-valuable items that can be vacuumed, based on a user indication. However, when items such as jewelry or coins are detected, the user may have previously provided input to not vacuum these items and to avoid the location where these valuable items are located. The machine learning or DNN may be trained based on previous detection of objects and actions taken with respect to these objects. Thus, various objects may be classified by an action directed by a user, or by a subsequent access to information related to having vacuumed a particular object. For example, a paperclip may have been vacuumed during a vacuuming operation. However, subsequent to the vacuuming operation, the user may not have attempted to access information related to vacuuming the paperclip. Thus, the action of vacuuming a paperclip may lead to the paperclip being classified as a non-valuable object. In future vacuuming operations, if the mobile vacuum cleaner detects a paperclip, the machine learning model may predict that the paperclip is a non-valuable object, and thus the action of the vacuum cleaner would be to proceed with vacuuming the paperclip. In contrast to a paperclip, a jewelry item such as a gold ring may have been vacuumed. However, the user may have subsequently searched the database to identify if a gold ring had been suctioned into the vacuum reservoir. The DNN may learn from these operations that the gold ring is a valuable object. In future vacuuming operations, if the mobile vacuum cleaner detects a gold ring, the machine learning model may predict that the gold ring is a valuable object, and thus the action of the vacuum cleaner would be to not vacuum the gold ring. As the DNN obtains more information about the various objects, the mobile vacuum cleaner can automatically make intelligent decisions without obtaining additional user input. The mobile vacuum cleaner may dynamically update a route map to optimize route planning. Furthermore, the mobile vacuum cleaner may be able to enter the location of the gold ring in a database and adjust maps of the room where the gold ring is located. As such, if the gold ring is not picked up off the floor for several weeks, the vacuum cleaner may continue to avoid vacuuming the gold ring.

As used herein, the term “mobile robot” may refer to any intelligent device with cleaning capability that is mobile such that it may move to different locations in a house or building either by self-power or by a user moving the mobile robot. Thus, mobile robots may include mobile devices with cleaning, identification, and/or classification capabilities such as robot vacuum cleaners, hand-held vacuum cleaners, self-powered vacuum devices, and/or other mobile devices used for object detection and/or cleaning. In some embodiments, a mobile robot may move to different locations in a house or building and identify objects.

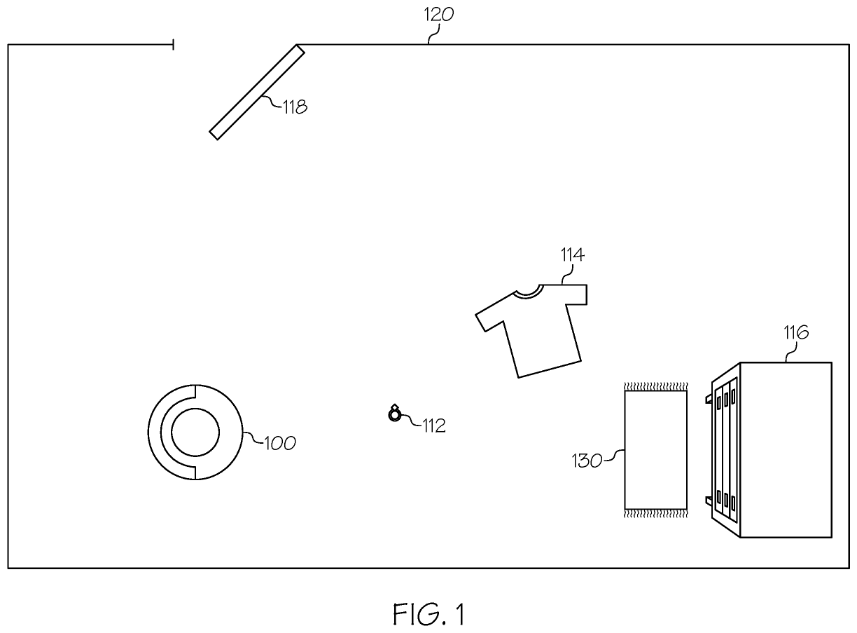

FIG. 1 illustrates an operating environment of a mobile robot device. Referring now to FIG. 1, a mobile robot 100, such as a robot vacuum cleaner or other type of cleaning device, has entered a room 120 that needs to be cleaned. The mobile robot 100 moves about room 120 and vacuums the floor. Various objects are on the floor in room 120, such as jewelry 112 that was dropped on the floor, a clothing item 114 that was placed on the floor, a rug 130, and/or a furniture object 116 having legs that elevate the furniture object 116 above the height of the mobile robot 100. Various sensors of the mobile robot device 100 may detect the jewelry 112 that has been dropped on the floor. Upon detecting the jewelry 112, the mobile robot 100 may send an alert to a user and/or avoid vacuuming the jewelry 112. As the mobile robot 100 traverses room 120, an article of clothing 114 such as a shirt or scarf may be detected. The mobile robot 100 may detect the article of clothing 114 and alter its path to avoid the clothing 114. The jewelry 112 and the clothing 114 may be catalogued in a database associated with the mobile robot 100. The mobile robot 100 may detect a rug 130 and may take actions such as altering settings to increase power while on rug 130 due to a difference in texture from the surrounding floor.

Still referring to FIG. 1, a door 118 may also be an obstacle that is inconsistent in its exact location in the room since the door 118 may be open, closed, or partially open to various degrees. During various operations of the mobile robot device 100, the DNN of the mobile robot device 100 may learn that the position of the door 118 is variable within an area range that corresponds to the swing area of the door. Based on identifying door 118, the mobile robot device 100 may use different path planning algorithms to ensure that the mobile robot device 100 will not close door 118 and trap itself inside room 120. The action recommended by the machine learning model may thus include the mobile robot device 100 avoiding the area range corresponding to the swing of the door, to avoid getting stuck on the door.

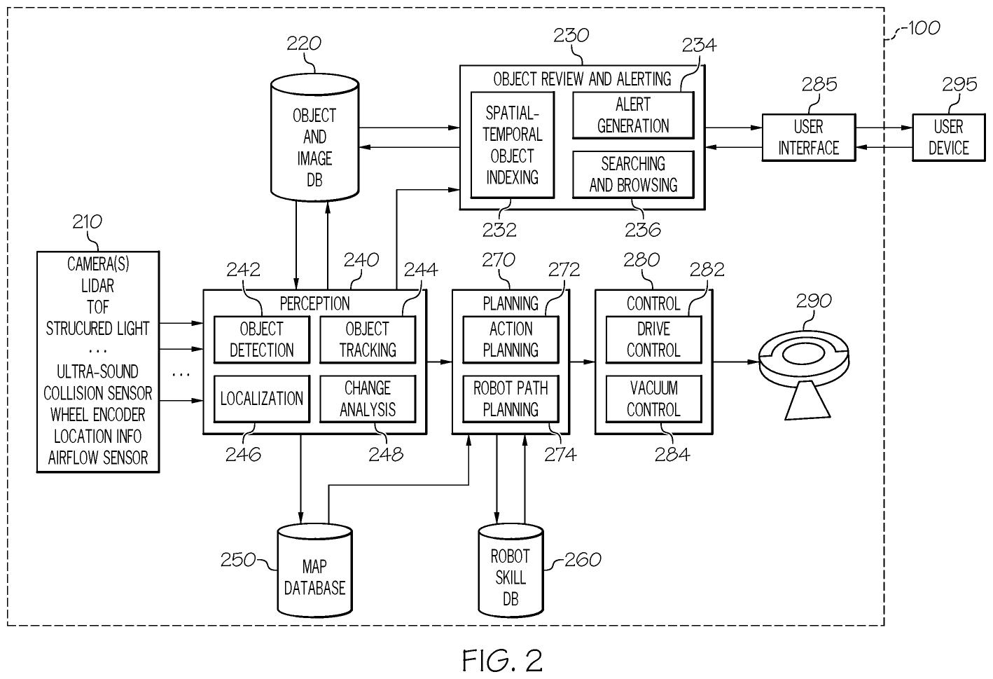

FIG. 2 illustrates various circuits and/or modules for object detection by the mobile robot device 100 in the room 120 of FIG. 1. The mobile robot device 100 may use various sensors 210 to detect objects in the room that it is vacuuming. Sensors 210 may include one or more cameras, LiDAR, time of flight (ToF) sensors, inertial measurement unit (IMU) sensors such as an accelerometer or gyroscope, location sensors, structured light sensors, ultrasound sensors, collision sensors, wheel encoder sensors, location information sensors such as Bluetooth, Wi-Fi, RF location, ultra-wideband, or near-field communication (NFC) sensors, airflow sensors, etc. These sensors 210 discern various conditions of mobile robot device 100 and provide a multifaceted representation of objects in the path of the mobile robot device 100. For example, cameras, LiDAR, and time of flight (ToF) sensors may allow the mobile robot device 100 to build a map of the room or house that includes patterns for efficiently vacuuming the room or house and avoiding obstacles. A structured light sensor may project a pattern on a surface of an object and compute distance based on reflections. Some obstacles, such as overhangs, mirrors, and glass walls, may not be seen by the range of the cameras, LiDAR, or structured light sensors so other sensors and post-processing based on the mobile robot device 100 getting stuck may be used to prevent future hindrances by these obstacles. Sensors 210 provide input to a perception circuit 240 that includes object detection circuit 242, object tracking circuit 244, localization circuit 246, and change analysis circuit 248. An object on the floor may be detected by the object detection circuit 240 based on input from one or more cameras, LiDAR, ultrasound, and/or other sensors. The location of the object is localized to a particular area within a room or building by the localization circuit 246.

Object tracking of any movement by the object or prior locations of the object may be performed by an object tracking circuit 244. The object detection circuit 242 and/or the object tracking circuit 244 may detect and track objects by using RGB images and depth information captured by forward-looking RGB, RGB-D, stereo cameras and/or LiDAR. Objects may be detected based on a trigger from the collision sensor and/or issues with the movement of the wheels when the mobile robot device 100 is stuck. For example, the wheel sensor may detect that the wheels are spinning, but the location of the mobile robot device 100 is not changing since it is not moving. The detected objects or obstacles may be further analyzed based on size, shape, and/or height to determine which small objects on the floor may be potentially vacuumed by the mobile robot device 100.

A confidence may be determined that indicates, for example, a value in an interval range from 0 to 1, the confidence of the identification of the object. If the confidence that a detected object is of value and should not be vacuumed is sufficiently higher than a predefined threshold, the mobile robot device 100 may re-plan its path and avoid traveling over and/or vacuuming the object. An alert may be sent to the user from an alert generation circuit 234 upon determining that a detected object is of value. When the user receives the alert, the user may have the option to overwrite the decision regarding whether or not to vacuum the object. If the object is determined by the user as an object that needs to be vacuumed, the robot may come back to clean the area of the object. The example of the object and the corresponding action that was taken may be added into a training database such as the object and image database 220 and/or the robot skill database 260. The robot skill database 260 may store the action that the mobile robot takes, such as types of cleaning, path of travel, etc. Including the detected object and corresponding action may improve the DNN learning regarding what to vacuum and what not to vacuum such that the machine learning algorithm may provide a more accurate prediction during future operation of the mobile robot device 100. Entries in the object and image database 220 may be categorized such that a user may search for types of objects that the mobile robot device 100 has encountered.

If the confidence that a detected object is of value and should not be vacuumed is lower than a predefined threshold, the robot will continue to vacuum as planned and the image chip of the object, which is a portion of an image of an object or a portion of an image of an area including the object that was detected, will be stored in the object and image database 220 as a candidate object vacuumed by the mobile robot device 100 during the specific cleaning process. The time and date of vacuuming of the detected object may be captured as metadata corresponding to the object.

In order to ensure that visible objects removed from the floor are captured, particularly objects that have not been recorded as removed by the above described techniques, the object review and alerting circuit 230 may compare images before vacuuming and after vacuuming to determine the changes to an area resulting from the removal of objects. The before and after images may be captured during normal cleaning operation when the mobile robot device 100 is traveling through the area. For those areas that are only imaged once during cleaning, a separate trip may be planned to capture the after image. Objects removed during cleaning and verified by the change analysis circuit 248 may further be clustered, cataloged and indexed for easy browsing, searching, and retrieval by the spatial-temporal object indexing circuit 232. The object review and alerting circuit 230 may also include a searching and browsing circuit 236 that allows a user to search by the location, and/or time of encounter of objects that the mobile robot device 100 has sensed.

In addition to receiving alerts from the alert generation circuit 234, a user may also browse and search the object and image database 220 to determine what objects are removed by mobile robot device 100. Therefore, review by a user of objects that were vacuumed may further prevent the loss of valuable objects. Potential obstacle objects may be also cataloged and a user is able to search, browse, and/or choose preferred actions for these obstacle obj ects.

Still referring to FIG. 2, changes to the presence of the object, location, or orientation of the object may be performed by the change analysis circuit 248. The perception circuit 240 provides information related to the object to a planning circuit 270. The planning circuit 270 may include an action planning circuit 272 and/or a robot path planning circuit 274. The action planning circuit 272 may determine which actions should be taken on the object, such as, for example, vacuuming the object, avoiding the object, providing a notification to a user, requesting user authorization to vacuum the object, and/or updating the robot skill database 260 with information regarding actions that are taken. The robot path planning circuit 274 plans, modifies, and/or deletes paths that the mobile robot device 100 follows during operation. The paths may be stored and/or retrieved from a map database 250. The perception circuit 240 may also store and/or retrieve path information from the map database 250.

The planning circuit 270 may provide action and path information to a control circuit 280. The control circuit 280 may include a drive control circuit 282 and a vacuum control circuit 284 that control the operations of the mechanical elements of body 290 of the mobile robot device 100. The mechanical elements of body 290 may include a motor, wheels, a driving mechanism, a vacuum, cleaning brushes, dust reservoir, a user interface to receive commands, one or more LED lights, etc. The body may include an indicator that is activated upon detection of a valuable object. For example, the indicator may be an LED light or an audio sound from the body 290 of the mobile robot 100 that alerts a user that a valuable object has been detected. The indicator may be configured to alert a user prior to vacuuming the valuable object and/or after a valuable object has been vacuumed. According to some embodiments, the indicator may provide a signal that is transmitted to a user device to alert a user that a valuable object has been detected and/or vacuumed.

The drive control circuit 282 may control the physical operation of the mobile robot device 100 such as motion, speed, direction, start/stop, etc. The vacuum control circuit 284 may control the vacuum and/or cleaning features of the mobile robot device 100 that include suction, brushes, etc.

The mobile robot device 100 may include a user interface 285 that provides alerts, receives input from a user device 295, and/or provides information regarding objects in the database to the user device 295. According to some embodiments, the user interface 285 may include controls and/or information display elements such as a display screen on the body 290 of the mobile robot device 100.

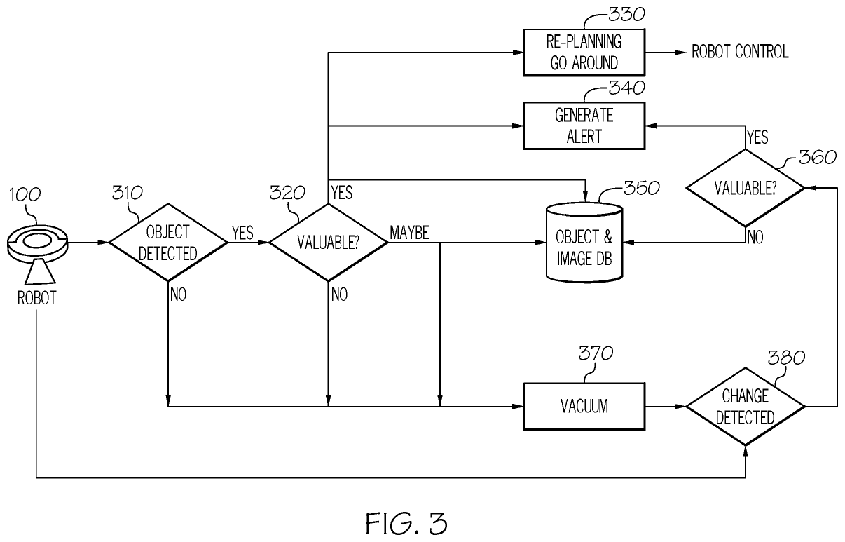

FIG. 3 is a flowchart of operations for object detection by mobile robot device 100 of FIG. 1 and FIG. 2. Referring to FIG. 3, mobile robot device 100 may attempt to detect an object in an area of the floor, at block 310. If an object is not detected in the area, the area may be vacuumed 370. If an object is detected in the area, then a check to determine if the object is valuable is performed, at block 320. If the object is not determined to be valuable, the object may be vacuumed 370. If the object is possibly valuable (i.e., maybe), then the object may be entered into the object and image database 350 and vacuumed 370. If the object is determined to be valuable, the object may be entered into the object and image database 350, an alert may be generated, at block 340, and the path of the mobile robot device 100 may be re-planned to not travel over (i.e., no vacuum) the area, as controlled by the control circuit 280 of FIG. 2. Determining if an object on the floor is valuable, at block 320, may include determining a confidence value and comparing the confidence to two different thresholds. If the confidence value is above a first threshold, then the object may be considered to be a valuable object. If the confidence value is below a second threshold, then the object may be considered to not be valuable. If the confidence value is between the first threshold and the second threshold, the object may be considered to be potentially valuable (i.e., maybe). Once an object is vacuumed, at block 370, images taken by the camera of the mobile robot device 100 may be compared to determine if a change is detected in the images, at block 380. Searching for changes to images may be useful in cases where a floor pattern may make it difficult to spot an object by other sensors, but a change in the image may indicate the presence of an object. If a change in the images is detected, a determination may be made, at block 360, to determine if an object in the changed image is valuable. If the object is determined to not be valuable, at block 360, then it may be entered in the object and image database 350. If the object is determined to be valuable, at block 360, then an alert may be generated, at block 340, to provide to a user.

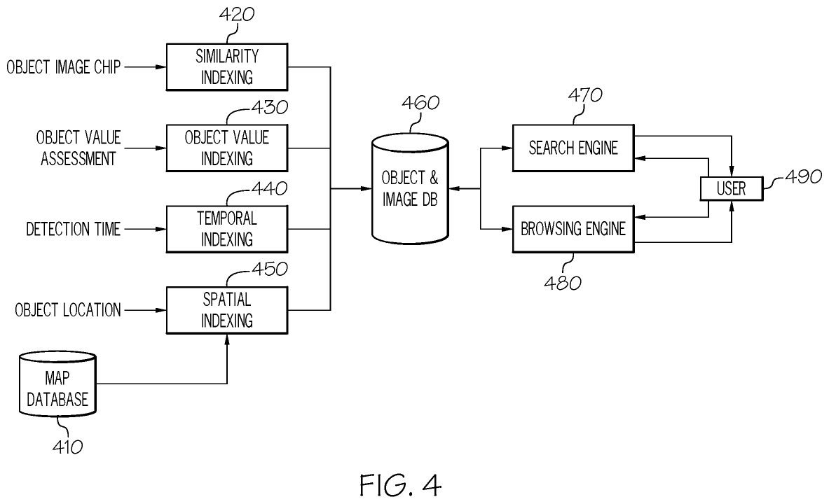

FIG. 4 is a flowchart of operations for object detection by mobile robot device 100 of FIGS. 1 to 3. Referring to FIG. 4, an object image chip, which is a portion of an image of an object or a portion of an image of an area including the object, may be input to a similarity indexing circuit 420, that determines a similarity index to objects in the object and image database 460 or other database of objects. An object value assessment may be performed by an object value indexing circuit 430 to assess if an object is valuable. The detection time of detecting the object on the floor may be used by the temporal index circuit 440 to determine if the object is a newly detected object or if the object was previously detected. Timestamps that are saved in the object and image database 460 may assist the temporal indexing circuit 440 to determine if the object has been on the floor for a period of time. This may also assist a user that is searching for an object that may have been vacuumed during a certain time window. For example, a user may suspect that they lost their gold ring on Friday or Saturday. The user can then search the object and image database 460 for a time period including Friday and Saturday to see if the mobile robot device 100 vacuumed the gold ring. The object location may be used by a spatial indexing circuit 450 to determine if the object is in the same or different location as previously detected. The location may be used to determine if an action was previously decided for the particular object. In addition to searching for an object in the object and image database 460, a search engine 470 may be used by user 490 to search for specific objects in the object and image database 460. The user may use a browsing engine 480 browse objects that have been entered in the object and image database 460. The object and image database 460, search engine 470, and the browsing engine 480 may use similarity clustering to group different types of objects. For example, a user may specify searching for only the jewelry type of objects that have been vacuumed, so the clustering of jewelry objects may be presented to the user for browsing.

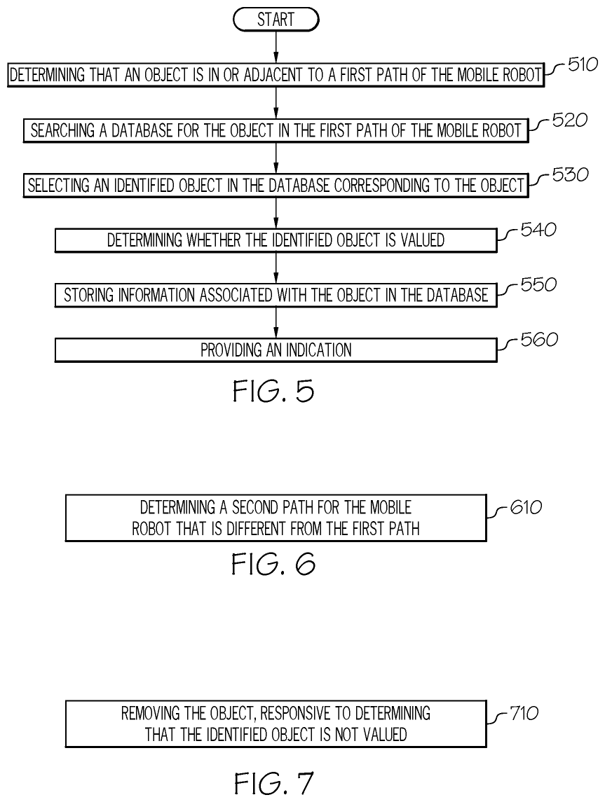

FIGS. 5 to 18 are flowcharts of operations of the mobile robot device 100 of FIGS. 1 to 3, according to some embodiments. Referring now to FIG. 5, operating a mobile robot may include determining that an object is in or adjacent to the first path of the mobile robot, at block 510. According to some embodiments, the object may include a gap between structures that may be an impediment to movement of the robot (i.e., the mobile robot may potentially get stuck in the gap). The mobile robot may want to avoid the gap or approach the gap from a different direction, to prevent getting stuck in the gap. The first path may be the path that is programmed for the mobile robot to travel while vacuuming the room, or may be related to an area in which the mobile robot will operate. The cameras or other detectors may be aware of an area that is wider than the footprint or path of the mobile robot. A database may be searched for the object that is in or adjacent to the first path of the mobile robot, at block 520. An identified object corresponding to the object is selected from the database, at block 530. Whether the identified object is valued may be determined, responsive to selecting the identified object in the database, at block 540. According to some embodiments, a gap between structures may be considered to be of value and thus avoided to prevent motion of the mobile robot from being impeded. Information associated with the object in the database may be stored, responsive to determining that the identified object is valued, at block 550. An indication may be provided, at block 560, responsive to determining that the identified object is valued. The indication may be transmitted to a user device to alert a user that a valuable object has been detected and/or vacuumed. The indication may be an LED light or an audio sound from the mobile robot that alerts a user that a valuable object has been detected. The indication may be configured to alert a user prior to vacuuming the valuable object or after a valuable object has been vacuumed. According to some embodiments, if the indication is activated by the mobile robot prior to vacuuming the path and/or area, the mobile robot may pause for a period of time before proceeding with vacuuming, in order to allow the user to react to the identification of a valuable object and/or interact with the mobile robot.

The mobile robot may decide not to vacuum the valued object. Referring now FIG. 6, a second path for the mobile robot that is different from the first path may be determined at block 610, responsive to determining that the identified object is valued, at block 540. The second path may be exclusive of the first path and/or area where a valuable object was located. Referring to FIG. 7, the object may be vacuumed, at block 710, responsive to determining that the identified object is not valued, at block 540. Referring to FIG. 8, a location of the object and/or a timestamp of when the object was detected to be of value or removed for lack of value may be stored in the database, at block 810.

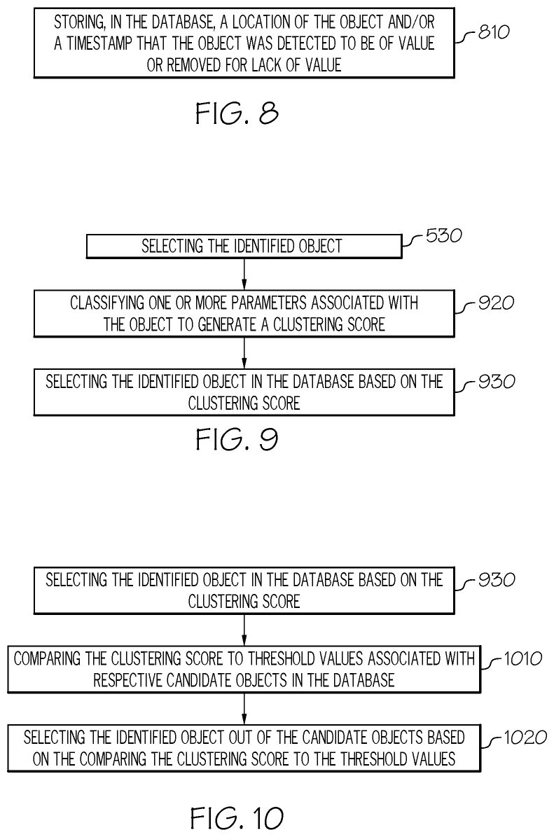

According to some embodiments, automatic selection of the object from the database may be performed using a deep neural network. Referring now to FIG. 9, selecting the identified object in the database may include classifying one or more parameters associated with the object to generate a clustering score, at block 920. The identified object may be selected based on the clustering score, at block 930. The one or more parameters may include a detection time, object location, object similarity, and/or object profile. Referring now to FIG. 10, selecting the identified object in the database based on the clustering score may include comparing the clustering score to threshold values associated with respective candidate objects in the database, at block 1010. The candidate objects are candidates in the database that may possibly represent the object. The clustering score may provide a confidence of the identification of the object. The identified object may be selected out of the candidate objects based on comparing the clustering score to the threshold values associated with respective candidate objects in the database, at block 1020.

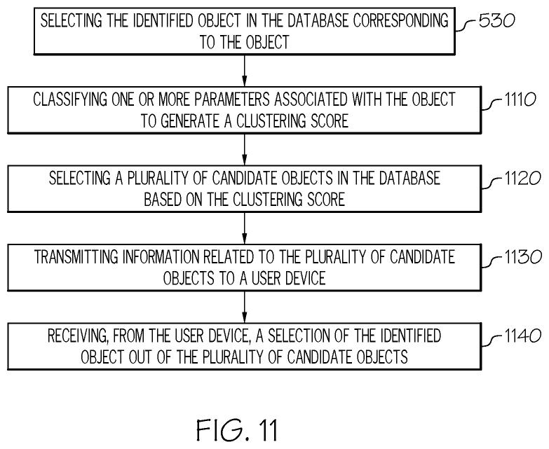

According to some embodiments, a user may select the object out of candidate objects that have been presented to the user. A listing of possible matches of the object on the floor may be presented to the user device such that the user may make a selection. Referring now to FIG. 11, selecting the identified object in the database corresponding to the object may include classifying one or more parameters associated with the object to generate a clustering score, at block 1110. A plurality of candidate objects that are possible matches for the object on the floor may be selected from the database based on the clustering score, at block 1120. Information related to the plurality of candidate objects may be transmitted to a user device, at block 1130. The mobile robot may receive, from the user device, a selection of the identified object out of the plurality of candidate objects, at block 1140.

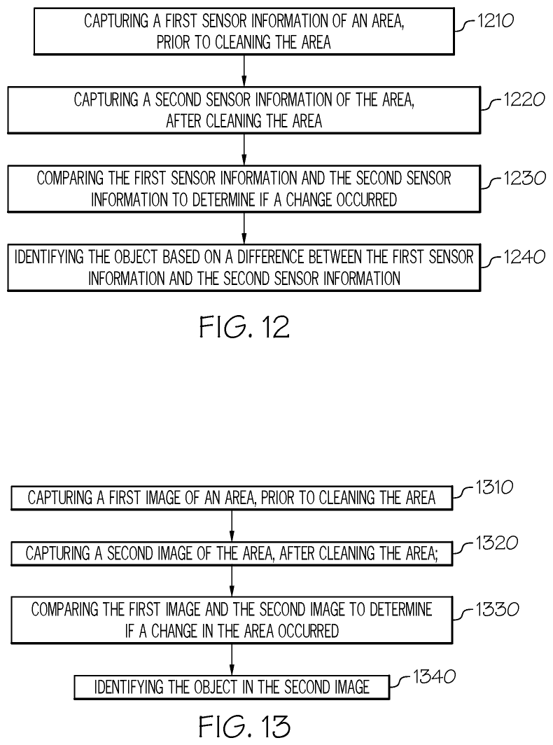

According to some embodiments, information regarding an area may be captured by sensors of the mobile robot both before and after cleaning or vacuuming the area. Information regarding the area may be captured by the sensors 210 of the mobile robot of FIG. 2, such as LiDAR, time of flight (ToF) sensors, location sensors, structured light sensors, ultrasound sensors, collision sensors, wheel encoder sensors, location information sensors, and/or airflow sensors. Referring to FIG. 12, a first sensor may capture information related to the area, prior to vacuuming or cleaning the area, at block 1210. A second sensor may capture information related to the area, after vacuuming or cleaning the area, at block 1220. The first sensor information and the second sensor information may be compared to determine if a change occurred, at block 1230. The object may be identified based on a difference between the first sensor information and the second sensor information, at block 1240, responsive to determining that the change occurred, at block 1230.

According to some embodiments, images of the area may be captured by one or more cameras of the mobile robot both before and after cleaning or vacuuming the area. Referring to FIG. 13, a first image of the area may be captured, prior to cleaning or vacuuming the area, at block 1310. A second image of the area may be captured, after cleaning or vacuuming the area, at block 1320. The first image and the second image may be compared to determine if a change in the area occurred, at block 1330. Responsive to determining that the change in the area occurred, the object in the second image may be identified, at block 1340.

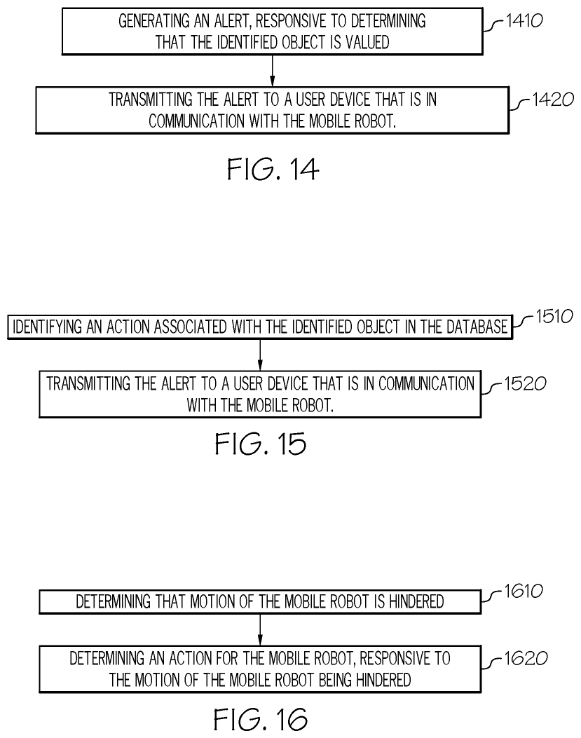

Referring to FIG. 14, an alert may be generated, at block 1410, responsive to determining that the identified object is valued. The alert may be transmitted to a user device that is in communication with the mobile robot. The alert may be transmitted over a wireless interface from the mobile robot to the user device. Referring to FIG. 15, an action associated with the identified object in the database may be identified, at block 1510. The action that was identified on the object may be performed, at block 1520.

The mobile robot may get stuck on an object, obstacle, or wall of a room. Referring to FIG. 16, it may be determined that an event such as when the motion of the mobile robot is hindered, at block 1610. Events such as the hindrance of motion may be determined using sensors such as a wheel encoder sensor that detects if the wheels are attempting to move, but the mobile robot is not in motion. Other sensors such as a location sensor or a gyroscope may be used to determine that the motion of the mobile robot is hindered. An airflow sensor may be used to determine if the intake is blocked by an object such as an article of clothing that was on the floor. An action for the mobile robot may be determined at block 1620, responsive to the motion of the mobile robot being hindered. Actions may include increasing power to the wheels if the texture of the object such a rug is hindering motion, changing a direction or path of the mobile robot, and/or sending an alert to a user device to request user intervention.

When the mobile robot moves freely and smoothly and its movement is not hindered, regions inside images, video frames, depth and point cloud data that are captured previously and are corresponding to where the robot just passed through are used to build appearance, texture or depth models of areas and surfaces that do not hinder the robot's movement. These objects and associated data are put into the object and image database 220 of FIG. 2 for future detection and reasoning of obstacles and free space in order to plan robot's trajectory and motion.

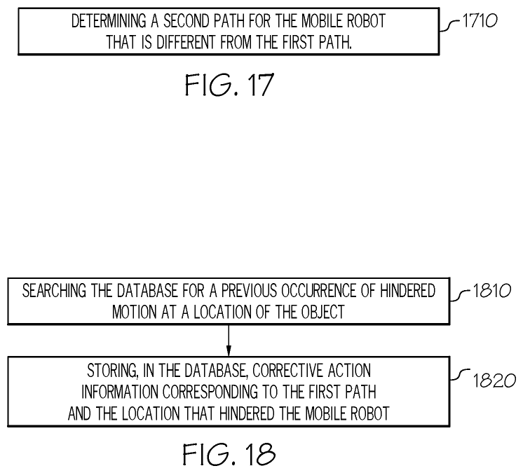

Referring to FIG. 17, a second path for the mobile robot that is different from the first path may be determined, at block 1710. The second path for the mobile robot does not include a location where the motion of the mobile robot was hindered. According to some embodiments, the same location may be vacuumed, but the approach of the mobile robot may be from a different direction than the direction of approach that experienced hindrance to the mobile robot. In these cases, the second path for the mobile robot may include a location where the motion of the mobile robot is hindered by the object, but the second direction of the second path to the location may be different from the first direction of the first path to the location.

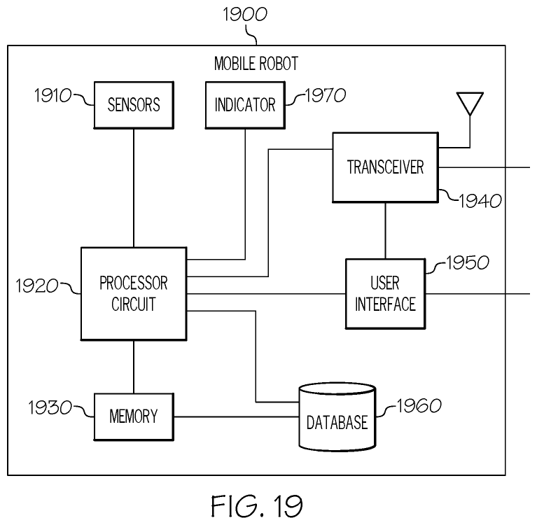

Referring now to FIG. 18, the database may be searched for a previous occurrence of hindered motion at a location of the object, at block 1810. The mobile robot may store, in the database, corrective action information corresponding to the first path and the location that hindered the mobile robot, responsive to not finding the previous occurrence of hindered motion at the location in the database, at block 1820.

FIG. 19 is a block diagram of mobile robot device 1900, such as the mobile robot 100 of FIGS. 1 to 3. Various elements of the mobile robot device 1900 may be integrated with the mobile robot 100 and/or may be external to the mobile robot 100 and may be configured to perform operations according to one or more embodiments disclosed herein. Referring to FIG. 19, the mobile robot device 1900 includes sensors 1910, a processor circuit 1920, a transceiver 1940, a user interface 1950, a database 1960, and/or a memory circuit 1930 containing computer readable program code. The processor circuit 1920 may include one or more data processing circuits, such as a general purpose and/or special purpose processor, e.g., microprocessor and/or digital signal processor, which may be collocated or distributed across one or more networks. The processor circuit 1920 may include one or more processors that are embodied by hardware, software, firmware, micro-code, etc. that support the operations of the one or more processors. The processor circuit 1920 is configured to execute the computer readable program code in the memory 1930 to perform at least some of the operations and methods described herein as being performed by the mobile robot device 1900. A user interface 1950 is coupled to the processor circuit 1920 and may communicate with a server, external network entity, and/or a user device, directly or indirectly. The mobile robot device 1900 may communicate via user interface 1950 through a transceiver 1940 that is configured to transmit and/or receive data from a user device. In some embodiments, the user interface 1950 may be a panel or other input on the body of the mobile robot device 1900 and may directly receive input from a user.

According to some embodiments, the memory 1930 may include a non-transitory computer-readable storage medium storing computer-readable program code therein that is executable by the processor circuit to perform various operations. The processor circuit 1920 may receive information from sensors 1910 and perform operations including determining that an object is in a first path of the mobile robot device 1900, searching a database 1960 for the object in or adjacent to the first path of the mobile robot device 1900, selecting an identified object in the database 1960 corresponding to the object, determining whether the identified object is valued, responsive to selecting the identified object in the database 1960, and storing information associated with the object in the database 1960, responsive to determining that the identified object is valued.

Still referring to FIG. 19, the mobile robot device 1900, may select the identified object in the database 1960 performing operations including classifying one or more parameters associated with the object to generate a clustering score, comparing the clustering score to threshold values associated with respective candidate objects in the database, and selecting the identified object among the candidate objects based on the comparing the clustering score to the threshold values. According to some embodiments, selecting the identified object in the database corresponding to the object includes classifying one or more parameters associated with the object to generate a clustering score and selecting a plurality of candidate objects in the database based on the clustering score. The transceiver 1940 may be configured to transmit information related to the plurality of candidate objects to a user device, such as user device 295 of FIG. 2. The transceiver 1940 may be configured to receive, from the user device, a selection of the identified object out of the plurality of candidate objects. According to some embodiments, an indicator 1970 may be activated upon detection of a valuable object. For example, the indicator may be an LED light and/or an audio sound from the body of the mobile robot that alerts a user that a valuable object has been detected. The indicator may be configured to alert a user prior to vacuuming the valuable object and/or after a valuable object has been vacuumed. According to some embodiments, the indicator may provide a signal that is transmitted by transceiver 1940 to a user device to alert a user that a valuable object has been detected and/or vacuumed.

### Further Embodiments:

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art, and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that, although the terms first, second, third, etc. may be used herein to describe various elements, and elements should not be limited by these terms; rather, these terms are only used to distinguish one element from another element. Thus, a first element discussed could be termed a second element without departing from the scope of the present inventive concepts.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination. Many variations and modifications can be made to the embodiments without substantially departing from the principles described herein. All such variations and modifications are intended to be included herein within the scope of the embodiments of the present invention.

1. A method for operating a mobile robot, the method comprising:
determining, based on input received from one or more sensors, that an object is in or adjacent to a first path of the mobile robot;
searching a database for the object in or adjacent to the first path of the mobile robot;
selecting an identified object in the database corresponding to the object;
determining whether the identified object is valued, responsive to selecting the identified object in the database;
storing information associated with the object in the database, responsive to determining that the identified object is valued; and
providing an indication, responsive to determining that the identified object is valued.

2. The method of claim 1, further comprising:
determining a second path for the mobile robot that is different from the first path, responsive to determining that the identified object is valued.

3. The method of claim 1, further comprising:
capturing first sensor information of an area, prior to cleaning the area;
capturing second sensor information of the area, after cleaning the area;
comparing the first sensor information and the second sensor information to determine if a change occurred; and
identifying the object based on a difference between the first sensor information and the second sensor information, responsive to determining that the change occurred.

4. The method of claim 1, further comprising:
capturing a first image of an area, prior to cleaning the area;
capturing a second image of the area, after cleaning the area;
comparing the first image and the second image to determine if a change in the area occurred; and
identifying the object in the second image, responsive to determining that the change in the area occurred.

5. The method of claim 1, further comprising:
removing the object, responsive to determining that the identified object is not valued.

6. The method of claim 5, further comprising:
storing, in the database, a location of the object and/or a timestamp of when the object was detected to be of value or removed for lack of value.

7. The method of claim 1, wherein selecting the identified object in the database corresponding to the object comprises:
classifying one or more parameters associated with the object to generate a clustering score; and
selecting the identified object in the database based on the clustering score.

8. The method of claim 7, wherein the one or more parameters comprise a detection time, object location, object similarity, or object profile.

9. The method of claim 7, wherein selecting the identified object in the database based on the clustering score comprises:
comparing the clustering score to threshold values associated with respective candidate objects in the database; and
selecting the identified object among the respective candidate objects based on the comparing the clustering score to the threshold values.

10. The method of claim 1, wherein selecting the identified object in the database corresponding to the object comprises:
classifying one or more parameters associated with the object to generate a clustering score;
selecting a plurality of candidate objects in the database based on the clustering score;
transmitting information related to the plurality of candidate objects to a user device; and
receiving, from the user device, a selection of the identified object out of the plurality of candidate objects.

11. The method of claim 1, further comprising:
generating an alert, responsive to determining that the identified object is valued; and
transmitting the alert to a user device that is in communication with the mobile robot.

12. The method of claim 1, further comprising:
identifying an action associated with the identified object in the database; and
performing the action that was identified on the object.

13. The method of claim 1, wherein responsive to not finding the identified object in the database, the method further comprises:
determining that an event of the mobile robot comprises the mobile robot not being hindered; and
determining an action for the mobile robot, responsive to the event of the mobile robot not being hindered.

14. The method of claim 1, further comprising:
determining that an event of the mobile robot comprises the mobile robot being hindered; and
determining an action for the mobile robot, responsive to the event of the mobile robot being hindered.

15. The method of claim 14, further comprising:
determining a second path for the mobile robot that is different from the first path.

16. The method of claim 15, wherein the second path for the mobile robot does not include a location where the event of the mobile robot was hindered.

17. The method of claim 15,
wherein the second path for the mobile robot comprises a location where the event of the mobile robot is hindered by the object, and
wherein a second direction of the second path to the location is different from a first direction of the first path to the location.

18. The method of claim 15, further comprising:
searching the database for a previous occurrence of the event at a location of the object; and
storing, in the database, corrective action information corresponding to the first path and the location where the mobile robot was hindered, responsive to not finding the previous occurrence of the event at the location in the database.

19. A mobile robot device, comprising:
a transceiver;
one or more processors coupled to the transceiver; and
a memory coupled to the one or more processors, the memory comprising a non-transitory computer-readable storage medium storing computer-readable program code therein that is executable by the one or more processors to perform operations comprising:
determining that an object is in a first path of the mobile robot device;
searching a database for the object in or adjacent to the first path of the mobile robot device;
selecting an identified object in the database corresponding to the object;
determining whether the identified object is valued, responsive to selecting the identified object in the database; and
storing information associated with the object in the database, responsive to determining that the identified object is valued.

20. The mobile robot device of claim 19, wherein selecting the identified object in the database corresponding to the object comprises:
classifying one or more parameters associated with the object to generate a clustering score;
comparing the clustering score to threshold values associated with respective candidate objects in the database; and
selecting the identified object among the respective candidate objects based on the comparing the clustering score to the threshold values.
